(19) United States
(12) Patent Application Publication
(10) Pub. No.: US 2006/0029273 A1
(43) Pub. Date: Feb. 9, 2006

(54) Physician communication system

(75) Inventors: Randolph B. Lipscher, Austin, TX (US); Eric Wohl, Austin, TX (US); Michael D. Dahlin, Austin, TX (US)

Correspondence Address: TOLER & LARSON & ABEL L.L.P., 5000 PLAZA ON THE LAKE STE 265, AUSTIN, TX, 78746, US

(73) Assignee: CATALIS, INC., Austin, TX (US)

(21) Appl. No.: 11/188,212

(22) Filed: Jul. 22, 2005

Related U.S. Application Data
(60) Provisional application No. 60/598,297, filed on Aug. 3, 2004.

(51) Int. Cl. G06K 9/62

(52) U.S. Cl. 382/156

(57) ABSTRACT

The disclosure is directed to a computer sever including a processor, communication circuitry accessible to the processor and configured to communicate with a data network and computer readable memory accessible to the processor. The computer readable memory includes computer implemented instructions operable by the processor to provide a medical data interface to a first remote device via the data network and computer implemented instructions operable by the processor to establish a packet-based voice communication link between the first remote device and a second remote device.

### CROSS-REFERENCE TO RELATED APPLICATION(S)

The present application claims priority from U.S. Provisional Patent Application No. 60/598,297, filed Aug. 3, 2004, entitled “PHYSICIAN COMMUNICATION SYSTEM,” naming inventors Randolph B. Lipscher, Eric Wohl, and Michael D. Dahlin, which application is incorporated by reference herein in its entirety.

### FIELD OF THE DISCLOSURE

This disclosure, in general, relates to physician communication systems.

### BACKGROUND

In medical facility settings it is desirable that medical professionals be accessible and easily located. For example, a physician in a hospital setting may visit various locations within the hospital, such as patient rooms, offices, and cafeterias. Generally, a nurse or staff member interested in contacting the physician pages or calls the physician using systems, such as pagers, cellular telephones, and intercoms. Similar methods may be used in emergency room settings, large clinical settings, and doctor office settings.

Intercom systems contribute to general noise within a hospital or clinical setting. Constant calls made through intercom systems lead to people typically tuning out intercom pages. As a result, people being paged over the intercom may miss or inadvertently ignore messages directed to them. In addition, it takes time to respond, which leads to subsequent pages and more noise disturbance in the hospital setting.

Cellular telephones and pager systems are more direct methods of contacting physicians. Such systems generally rely on cellular and pager networks that often extend beyond the bounds of the hospital or clinic and have been known to present security problems. Messages sent to and from pagers, and calls to and from cellular telephones may be intercepted and sensitive patient information may be disseminated. Typically, cellular telephones and pagers further contribute to noise problem. In addition, typical pager systems and cellular systems are limited in the amount and type of information that may be passed to a physician receiving a call or page.

As such, an improved system and method for communicating with medical professionals would be desirable.

### SUMMARY

In one particular embodiment, the disclosure is directed to a computer sever including a processor, a communication module accessible to the processor and configured to communicate with a data network and computer readable memory accessible to the processor. The computer readable memory includes computer implemented instructions operable by the processor to provide a medical data interface to a first remote device via the data network and computer implemented instructions operable by the processor to establish a packet-based voice communication link between the first remote device and a second remote device.

In another embodiment, the disclosure is directed to a medical data communication device including a processor, a communication module accessible to the processor and configured to communicate with a data network, interface devices accessible to the processor and memory accessible to the processor. The data network provides a data packet-based voice communication channel. The memory includes computer implemented instructions operable by the processor to display a medical data interface using the interface devices and computer implemented instructions operable by the processor to communicate using the data packet-based voice communication channel.

In a further embodiment, the disclosure is directed to a method for interacting with a medical professional. The method includes displaying a medical data interface on a wireless interface device and establishing a packet-based voice communication link between the wireless interface device and a remote device.

In another embodiment, the disclosure is directed to a method of interacting with a medical professional. The method includes providing medical data interface data to a remote interface device via a data network and establishing a packet-based voice communication link with the remote interface device via the data network.

In a further embodiment, the disclosure is directed to a medical interface device having a screen configured to display a graphical user interface including a set of discrete input medical findings entry controls configured to receive and display medical findings data and a communications control element operable to establish a voice-over data network communications link.

The disclosure is also directed to a system including first and second medical data interface devices and a computer server. The computer server is configured to provide a medical data interface to a first remote device via the data network and is configured to establish a packet-based voice communication link between the first remote device and the second remote device.

### BRIEF DESCRIPTION OF THE DRAWINGS

FIG. 1 includes an illustration of an exemplary system for communicating with a medical professional.

FIG. 2 includes an illustration of an exemplary medical data interface server.

FIG. 3 includes an illustration of an exemplary wireless interface device.

FIGS. 4, 5, and 6 include illustrations of exemplary methods for facilitating communications with a medical professional.

FIG. 7 includes an illustration of an exemplary medical findings interface.

FIG. 8 includes an illustration of an exemplary selection screen.

### DETAILED DESCRIPTION OF THE DRAWING(S)

In a particular embodiment, the disclosure is directed to a system including a set of wireless interface devices and a medical data interface server. The medical data interface server is configured to provide a medical data interface to the wireless interface devices. In addition, the medical data interface server is configured to establish a packet-based-voice communications link, such as an Internet Protocol (IP) network-based voice communications link (e.g. a voice-over-IP (VoIP) communications link) between wireless interface devices over a network. In one exemplary embodiment, the network includes a wireless network portion.

In another embodiment, the disclosure is directed to wireless interface devices configured to display and implement a medical findings interface and configured to communicate using packet-based voice communications. In a further embodiment, the disclosure is directed to a medical interface server configured to provide medical data interfaces to and to establish a packet-based voice communications link between medical interface devices.

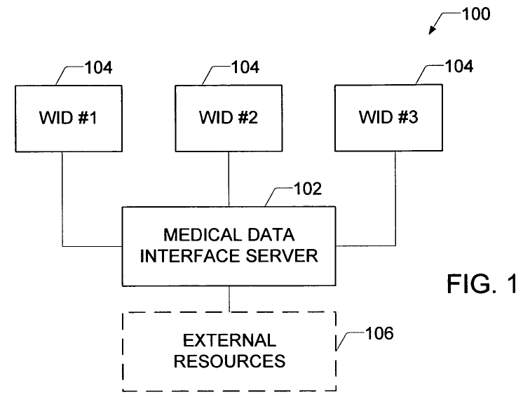

In one exemplary embodiment, a system for communicating with medical professionals is depicted in FIG. 1. The system 100 includes a medical data interface server 102 communicatively coupled to a set of wireless interface devices 104. The medical data interface server 102 is communicatively coupled to the wireless interface devices 104 using a network that may included both a wired portion, a wireless portion or both. For example, the medical data interface server 102 may communicate with the wireless interface devices 104 via a wireless hub or router. Alternatively, the medical data interface server 102 may include communications circuitry configured to communicate wirelessly with the wireless interface devices 104. For example, portions of the network may use wireless protocols such as IEEE 802.11x, IEEE 802.15, and IEEE 802.16. The wireless portion of the network may also use protocols, such as the wireless application protocol (WAP) and encryption mechanisms, such as wired equivalency privacy (WEP) and Wi-Fi protected access (WPA). In general, the network is an IP-based network or an Ethernet-based network and facilitates communication using packet based data transfer. In other examples, the network and communication associated with the network may use encryption, authentication, and privacy protocols, such as Kerberos, IPSec, Secure Shell (SSH), RSA public key, Blowfish, Data Encryption Standard (DES), International Data Encryption Algorithm (IDEA), and others.

The medical data interface server 102 may be coupled to external resources 106. These external resources 106 may be accessed for updating of medical data on the medical data interface server 102. For example, the external resources 106 may act to update software on the medical data interface server 102 and the wireless interface devices 104. In another example, the external resources 106 may provide additional medical data to the medical data interface server 102 such as formularies, insurance plan updates, additional patient medical information, medical research study information and medical publications. In a further example, the external resources 106 may include remote medical data interface servers, such as medical data interface servers associated with separate medical facilities, or a central data server connected to medical data interface servers at several medical facilities.

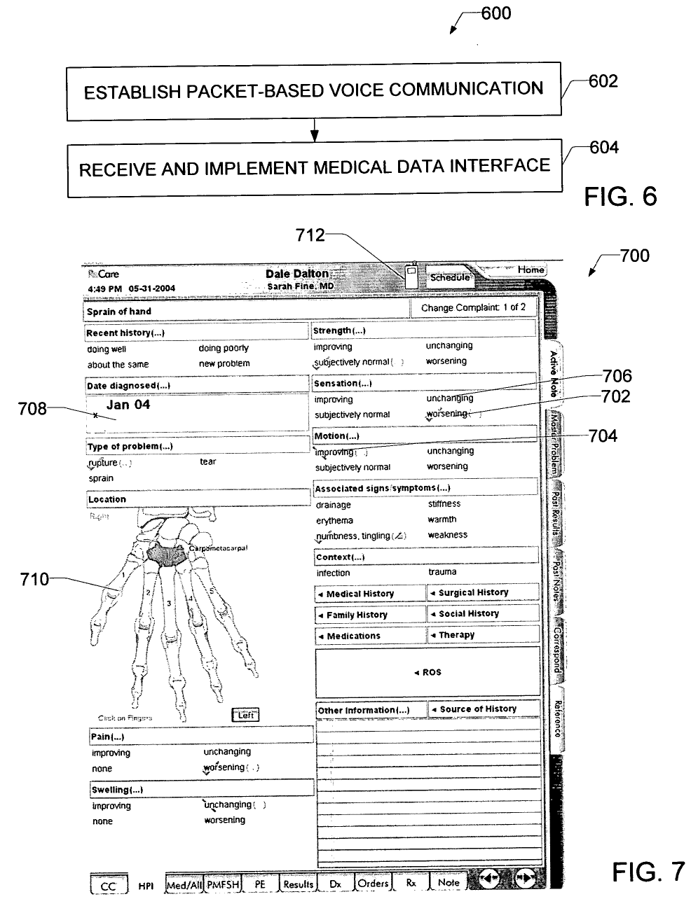

In one exemplary embodiment, the wireless interface devices 104 are portable computational devices, such as personal digital assistants (PDA), hand held circuitries, and tablet based or pad-based portable computers. The medical data interface server 102 interacts with the wireless interface devices 104 to provide a medical data interface, such as a discrete input medical interface that allows entry of discrete findings associated with a patient. An exemplary discrete input interface is depicted in FIG. 7, which allows selection of discrete input controls that relate to discrete findings, such as conditions, states, disease characteristics, diagnoses, medical/family/social history information, test results, orders, and prescriptions.

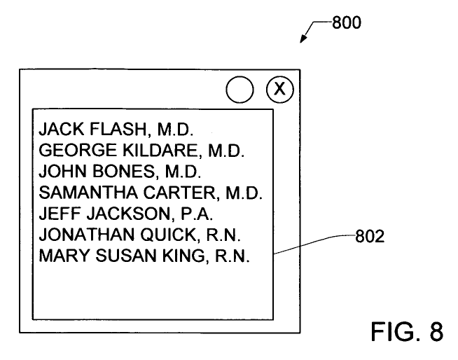

In addition, the medical data interface server 102 may interact with the wireless interface devices 104 to establish a packet-based voice communications link between wireless interface devices 104. For example, the medical data interface server 102 may provide a selection interface to a wireless interface device 104, such as wireless interface device (WID) #1. The selection interface may include a listing of available wireless interface devices or medical professionals associated with those devices. FIG. 8 illustrates an exemplary selection interface. Upon selection of a medical professional or a wireless interface associated with the medial professional, the system establishes a packet-based voice communications link between the wireless interface device 104, such as WID #1 and another wireless interface device 104, such as WID #2. In one particular embodiment, the communications link includes packet-based voice communications, such as voice-over-IP (VoIP) and other data network based voice communications. In an exemplary embodiment, the system permits communication between medical professionals at remote locations. In such an embodiment, the selection interface may include a control for selecting a clinic or medical facility location.

In one exemplary embodiment, the packet-based voice communications link is established using voice over data network protocols, such as, for example, International Telecommunications Union (ITU) H.323, session initiation protocol (SIP), or other IP-telephony protocols. In one particular embodiment, the medical data interface server 102 may create a communications socket, such as a TCP socket, between the requesting device (e.g., WID #1) 104 and the server 102 and a communications socket between the requested device (e.g., WID #2) 104 and the server 102. In another embodiment, a WID may create a communications connection, such as a TCP connection between itself and the server. In a further exemplary embodiment, the server 102 provides network address data associated with the requested device, such as IP address data, to the requesting device (e.g. WID #1) 104 with which the requesting device (e.g. WID #1) 104 may contact the requested device (e.g. WID #2) 104 and establish the communications link. In alternative embodiments, the devices may interact using TCP/IP or UDP/IP protocols.

For example, a nurse in an emergency room or clinical setting may interact with a patient to determine discrete input medical findings associated with the patient. The nurse may contact an on-call physician using the packet-based voice communications system to discuss the condition of the patient. Medical data provided by the nurse is stored on the medical data interface server 102 and, in conjunction with the packet-based voice communication, is accessible by the physician via the physician's wireless interface device. In this manner, the physician may be contacted by the nurse and provided with a medical data entry interface associated with the patient, and, in particular, a medical data entry interface populated with findings data or history data associated with the patient.

In one exemplary embodiment, a first user enters data into an electronic medical record or chart and initiates a connection to a second user regarding the chart. The second user is notified of incoming request, such as through identifying the first user and patient or subject of the call. For example, the first user may have selected the subject of the initiated call. When the second user activates the call, the interface device displays the chart of the selected patient and allows voice communication between the first user and the second user. The interfaces may include different locking and sharing privileges. For example, the chart may be visible to both users. In another example, the chart is editable by the first user and not the second user. Changes made to the interface by the first user are displayed to the second user. In a further example, the chart is editable by the second user and not the first user. Changes made to the interface by the second user are displayed to the first user. In another example, the chart is editable by both wherein changes to the chart by one user are displayed on both interfaces. In a further exemplary, the chart may become inaccessible, shadowed, grayed, or invisible to the first user when accessed by the second user and control return to the first user when the communication ends.

In another example, a wired interface device, such as a receptionist using a desktop computer, initiates contact with a physician using a wireless interface device. For example, the receptionist or a back-office person may contact the physician regarding billing or insurance questions. In a particular embodiment, an insurance company may have been contacted regarding authorization to perform a procedure. The receptionist may communicate with a nurse or physician to request additional information for the insurance company or the physician may communicate directly with the insurance company through an interface to a telephone system.

In another example, a patient calls a clinic, and the clinic phones may be answered by a nurse or receptionist. The patient may ask to speak with Dr. Smith. The nurse or receptionist selects the patient's chart from the system and initiates a call to Dr. Smith. When Dr. Smith answers the call from her device, her device displays the calling patient's chart and provides a voice interface to the receptionist. After reviewing the chart and speaking with the receptionist, the doctor may update the chart (e.g., to enter a prescription refill order) or give verbal instructions to the receptionist. In one embodiment, the receptionist may transfer the patient's call to Dr. Smith, who may speak with the patient while reviewing and/or updating the patient's chart. In another example, the medical data interface server 102 may include a connection to a remote medical data interface server. In this example, medical professionals at a first location associated with the medical data interface server 102 may communicate with medical professionals at a remote location having the remote medical data interface server.

In a further example, a wireless interface device may connect to the medical data interface server 102, for example, using a TCP connection, or establishing a Virtual Private Network (VPN) connection. In this manner, a medical professional located in a remote location, such as another floor of a hospital, a remote clinic, a cafeteria, or a wireless enabled coffee shop, can be contacted.

In another example, a wireless interface device may register with a nearby medical data interface server and, as a result, be accessible to devices connected to remote medical data interface servers. For example, a physician may move from clinic to clinic and be accessible in each location.

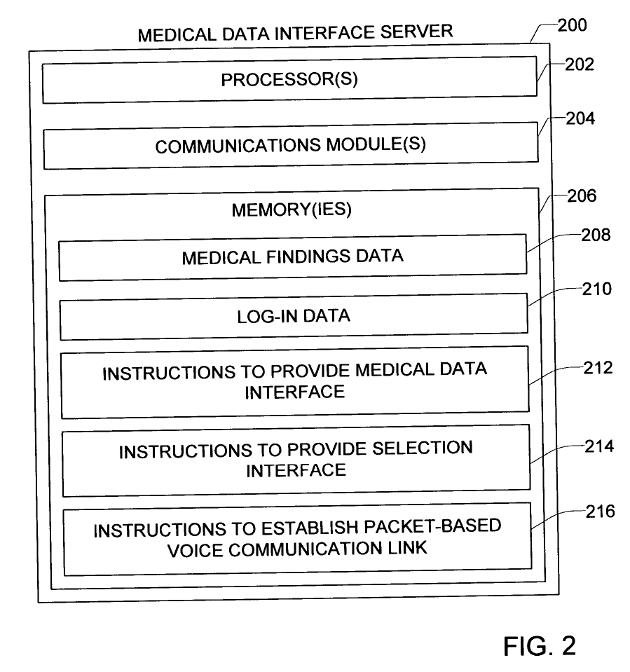

FIG. 2 depicts an exemplary embodiment of a medical data interface server 200. The medical data interface server 200 includes processors 202, communications module 204, and computer readable memory 206. The computer readable memory 206 includes medical findings data 208, log-in data 210, instructions to provide medical data interfaces 212, instructions to provide selection interfaces 214, and instructions to establish packet-based voice communications links 216.

The communications module 204 is accessible to the processor and is configured to communicate with a network that includes a wireless network portion. For example, the communications module may include a wired network connection, such as an Ethernet connection, that communicates with a wireless router or hub. Alternatively, the communications module 204 may act as a wireless router or hub. The wireless portion of the network may communicate using wireless standards for data networks, such as IEEE 802.11x, IEEE 802.15, and IEEE 802.16. In general, the communications module 204 communicates using data packets over IP-based or Ethernet-based networks.

The memory 206 is accessible to the processor 202 and may include RAM, ROM, magnetic media, optical media, CDs, DVDs, hard drives, floppy drives, removable drives, and network-based storage. The memory includes instructions to provide medical data interfaces 212, such as computer-implemented software which may be operable by the processor to generate and transmit a medical data interface to wireless interface devices via the communications circuitry 204. The instructions to provide the medical data interfaces 212 may be configured to access medical findings data 208 and, through interaction with the wireless interface devices, the medical data interface server may act to provide, collect, gather, and store medical findings data. Medical findings data 208 may, for example, include patient personal data, family medical and social histories, current medical findings, prescription data, medical orders and test results. In a particular embodiment, the medical findings data 208 includes discrete input findings and is presented in a medical data entry interface as bi-state interface controls, tri-state interface controls, and radio buttons. In one exemplary embodiment, the medical data interface is a web-based interface, such as an HTML-based interface, or includes data files, such as XML data files.

The memory 206 also includes instructions to provide a selection interface 214. The instructions to provide a selection interface 214 are operable by the processor 202 to provide data associated with wireless interface devices on the network and/or medical professionals associated with wireless interface devices located on the network. The selection interface may, for example, take the form of HTML or XML files. The system may access log-in data 210, such as a list of individuals logged into the system, to generate the selection interface. When provided to a wireless interface device, the selection interface allows selection of a medical professional or a wireless interface device located on the network, and, in response to receiving a selection, the system establishes packet-based voice data communications links with the selected wireless interface device. Instructions to establish a packet-based voice communications link 216 may facilitate the establishment of the voice communications link by interacting with the sub-set of wireless interface devices and receiving and transmitting voice data packets to and from the wireless interface devices. Alternatively, the server may provide each wireless interface device selected in the communication with appropriate network addresses and requests for establishing the communications link.

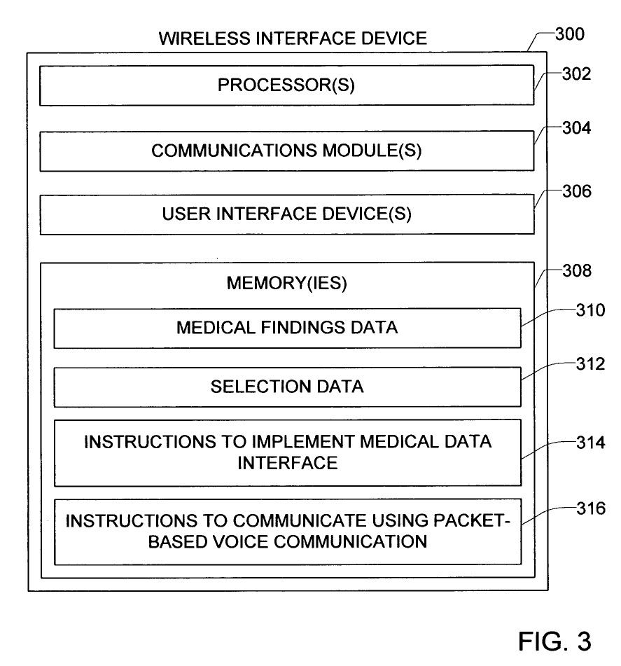

FIG. 3 depicts an exemplary wireless interface device 300. The wireless interface device 300 includes processors 302, communications module 304, user interface devices 306 and memory 308. Memory 308 may include medical findings data 310, selection data 312, instructions to implement the medical findings interface 314, and instructions to communicate using packet-based voice communication 316. The instructions, 314 and 316, may be implemented as computer-implemented software operable by the processors 302.

The communications module 304 is accessible by the processor 302 and is configured, at least in part, to communicate via a wireless network protocol, such as IEEE 802.11x, IEEE 802.15, and IEEE 802.16. In general, the communications module 304 is configured to communicate with packet-based communications networks, such as IP-based or Ethernet-based data networks.

The user interface devices 306 include display and human interaction devices for implementing a graphic user interface. For example, a system may include touch screens, pens, mice, keyboards, microphones, speakers, and buttons. A user of the wireless interface device 300 may interact with the user interface devices 306 to access, read, and provide medical findings data and to communicate using packet-based voice communication. In one exemplary, the user interface devices 306 include a microphone and a speaker, such as an analog microphone and speaker, USB microphone and speaker or a short range wireless system, such as Bluetooth® wireless network to a Bluetooth® enabled handset or headset.

Memory 308 is accessible by the processor 302 and may include RAM, ROM, magnetic media, optical media, CDs, DVDs, hard drives, floppy drives, removable drives, and network-based storage. Using instructions to implement medical findings interface 314, the wireless interface device 300 may interact with a wireless interface device server to acquire medical data 310 and implement a graphical user interface, in conjunction with the user interface devices 306, that allows display and entry of the medical data 310. In one exemplary embodiment, the medical findings interface is implemented as a web-based interface, such as an HTML interface. In another exemplary embodiment, the instructions 314 interpret data files, such as XML data files, to implement the graphical user interface.

In addition, the system includes instructions to communicate using packet-based voice communications 316 that may be used to communicate with other wireless interface devices. For example, a wireless interface device server may provide selection data 312 that may be provided in a selection interface to the user via the user interface devices 306. A user may select a wireless interface device or a name from a list of medical professionals associated with wireless interface devices and, using the instructions to communicate using packet-based voice communications 316, establish a communication with the selected medical professional or wireless interface device associated with the medical professional. For example, the instructions to communicate with the packet-based voice communication 316 may include instructions to implement a voice over data network communications link or VoIP communications link with the medical data interface server or with other wireless interface devices on the network. In one exemplary embodiment, the instructions to communicate using packet-based voice communications 316 are implemented as Java-based programs. However, the instructions 316 may be implemented using various interpreted or compiled languages, such as C, C++, and Visual Basic.

In one exemplary embodiment, a medical professional, such as a nurse practitioner, collects data associated with a patient and desires to communicate with a second medical professional, such as a physician. The data collected in association with a patient is stored on the medical data interface server, and the first medical professional accesses a selection interface to select the desired second medical professional. A voice communication link is established with the second medical professional and the second medical professional accesses the data associated with the patient stored on the medical interface server while discussing the data with the first medical professional.

In another exemplary embodiment, a medical professional, such as a physician is contacted using a packet-based voice communication transmitted over a wireless network to a wireless interface device associated with the medical professional. For example, the communications may relate to patient or medical information. The medical professional accesses a medical data entry interface associated with the patient or medical information and provides input or reviews the medical data. In one exemplary embodiment, the medical data interface associated with the patient is provided concurrently with the voice communications.

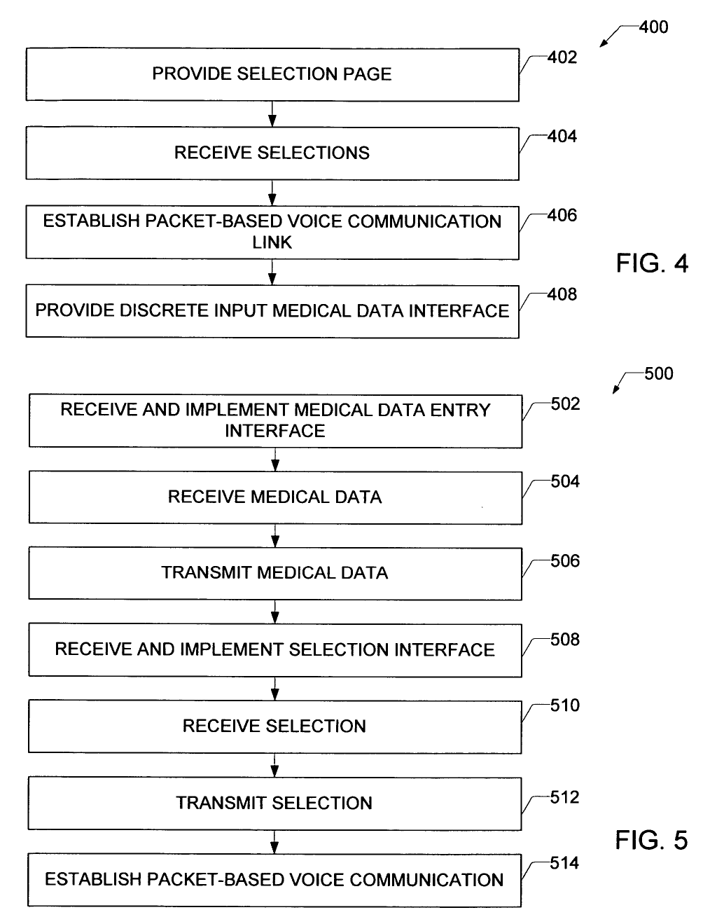

Generally, the medical data interface server provides medical data interfaces to wireless interface devices associated with medical professionals within the coverage area of a wireless network. When requested, the medical data interface server provides a selection page, as illustrated at 402 of FIG. 4. The selection page may include a listing of medical professionals associated with devices accessible by the wireless network. Using the selection interface, a medical professional selects an individual or wireless interface device associated with an individual on the network. The medical data interface server receives the selection, as illustrated at 404, and establishes a packet-based voice communication link with the selected wireless interface device or between the selecting wireless interface device and the selected wireless interface device, as illustrated at 406. The voice communication may utilize communications using standards, such as VoIP and other voice over data network standards. When requested or in conjunction with the packet-based voice communication link, the medical data interface server provides a discrete input medical interface to the selected wireless interface device, as illustrated at 408. For example, the medical data interface server may provide a discrete input interface that includes medical data associated with a patient and allows entry of data and findings associated with that patient.

In one embodiment, providing discrete input medical data interface 408 precedes processes 402, 404, 406. A discrete input medical data interface may also be provided to the wireless interface device prior to, concurrently, or after any of processes 402, 404, 406, and 408. In this embodiment, the user uses the discrete input interface to select a patient and enter discrete medical findings about the patient (e.g., history of present illness findings, physical exam findings, etc.). The user then uses the system's receive selection interface to select a second user with whom to communicate, and the system receives the selection and establishes a voice communication link. Because the connection between the user and the second user was established within the context of the selected patient and current medical chart (e.g., the selection page interface is accessed via a link “voice communicate regarding current patient”), the system associates the voice connection with the specified patient and can provide the patient's information in the discrete medical data interface presented to the second user in association with this call.

In one embodiment, the user initiating a call regarding a patient can select whether to make the chart visible to the user receiving the call. This functionality may be selected via selections page, which provides a list of users and an on-screen toggle (e.g., a checkbox) to select whether the chart should be made visible. In one exemplary embodiment, the visibility of a chart can be changed during the call. In such an embodiment, the system displays an interface to the initiating user during the duration of the call, and this interface allows the initiating user to select “do not make chart visible to remote user”, “make chart visible to remote user”, “make chart visible to and editable by remote user.” If the user selects one of these options, the system provides an interface to the remote user that corresponds to the selected mode.

FIG. 5 depicts an exemplary method 500 for use by a wireless interface device. A wireless interface device receives and implements a medical data entry interface, as illustrated at 502. For example, the wireless interface device receives medical data associated with a patient and provides a graphical user interface that enables entry of medical data by a medical professional, as illustrated at 504. Entered medical data is transmitted to the medical data interface server, as illustrated at 506.

The medical professional may access a selection interface to establish a packet-based voice communication link with another medical professional. For example, the system receives and implements a selection interface from a medical data interface server, as illustrated at 508. The medical professional selects a wireless interface device or another medical professional associated with a wireless interface device, as illustrated at 510. The wireless interface device transmits this selection to the medical data interface server, as illustrated at 512, and interacts with the server to establish a packet-based voice communications over the wireless data network, as illustrated at 514. While processes 502, 504 and 506 are depicted prior to steps 508, 510, 512 and 514, these steps may occur concurrently, with, or after the other method steps.

In one exemplary embodiment, a nurse interacts with a patient to determine a set of discrete input medical findings. The nurse requests a selection interface, and through that interface, selects a physician associated with a wireless interface device connected to the network. The wireless interface devices establish a packet-based voice communications link, allowing the nurse to communicate with the physician. In addition, the physician accesses the set of discrete input medical findings received from a medical data interface server that stores the findings data entered by the nurse.

FIG. 6 depicts a further method 600 for use by the wireless interface device. The method 600 includes establishing a packet-based voice communication, as illustrated at 602. For example, a medical data interface server interacts with a selected wireless interface device to establish packet-based voice communication. For example the device may provide an indication that a voice communication is requested, such as providing an audio indication, such as a ring or audible message, or provide a visual clue, such as a flashing icon or pop-up window that indicates a request for voice communication. The wireless interface device user may select the icon, push a button or otherwise indicate acceptance of the voice communications. The wireless interface device and the medical data interface server may include instructions that permit establishment of a link to allow packet-based voice communications with another wireless interface device. In addition, the wireless interface device may receive and implement a medical data interface, as illustrated at 604. For example, if the voice communication is associated with a patient, the medical professional may access a medical data interface, such as a discrete input medical findings interface associated with that patient. In one exemplary embodiment, the professional requests the interface. In another exemplary embodiment, the interface is provided in conjunction with the establishment of the voice communications link, such as when the wireless interface device user accepts the packet-based voice communications link.

FIG. 7 depicts an exemplary medical findings data entry interface. The interface includes a set of discrete input controls, such as discrete input controls 702, 704, and 706. In this exemplary embodiment, a user may interact to input medical findings data associated with a patient. For example, the user may indicate the presence of an item as illustrated by control 702, absence of an item as illustrated by control 704, or no comment as illustrated by control 706. The interface may include additional controls that permit annotation, pictorial representation, or selection of a finding, or text entry of comments, such as controls 708 and 710. In addition, the interface may include an icon or control element that indicates a request for a packet-based voice communication, existence of a voice-communication link, or absence of a communication link. For example, control element 712 may flash when an incoming request has been received. The user may select the icon 712 to accept the request. Once a communication link is established, the control 712 may be presented as a solid icon or as an icon different form the icon used to indicate an incoming communication request. When a communication link is not present, the control may fade or take a third form. In one exemplary embodiment, a user may select the control icon 712 to request a selection interface for establishing a communication link with another device.

FIG. 8 depicts an exemplary selection interface 800. The exemplary selection interface includes a listing of available medical professionals 802. Once selected, the system may establish communication with the selected medical professional.

In one particular embodiment, the medical data interface, such as the interface depicted in FIG. 7 is implemented in a browser. The selection interface, such as the interface illustrated in FIG. 8 may be implemented in the browser, such as using HTML Javascript or Java applets interfaces to common gateway interface (CGI) program at a server, or using an application separate from the browser, such as a Java-based, C-based, C+-based, or NET-based program. The packet-based voice communication may be implemented with a separate program accessible via the browser.

In one exemplary embodiment, the wireless interface device includes a client program for voice communication, which starts automatically when the wireless interface device boots or a user logs in. The client program may register with a server, such as a medical data interface server and identify that a user is accessible via the wireless interface device's address. The client program may listen for incoming connections or establish a TCP connection with the server over which the server will send notifications regarding to whom to talk and/or to whom to send voice packets. In this example, a browser link at a first user may activate a program at a server, such as through CGI, JSP, serverlet, or ASP. The program at the server communicates with the client communication program located on an interface device associated with a selected user. The selected user is notified of the communication request. The browser link activated by the first user may also activate a program at the server to send a patient record to the interface device associated with the selected user. The server, in response to permissions and requests, establishes the 2-way voice communication between the wireless interface devices.

In another example, browsers included with the wireless interface device may use audio plug-in technology, VOIP plug-in technology, or Java Applets using the Java Sound API, such as javaax.sound.sampled. A browser may access a page that allows a user to select another user. The selected user may receive a notification of incoming calls, such as through a sound or displayed icon. When the selected user selects an icon or link configured to indicate acceptance of the call, the browsers may display pages, frames, or layers, that include the 2-way audio plug-in and patient data.

While the apparatus is described in relation to voice and audio communications, the system may also be used to provide text chat and video conferencing features. Text chat may be useful in situations where voice communications do not provide privacy. In another embodiment, one user may send text features while another uses voice. For example, a first user may enter text chat communications that are displayed to a second user who responds using voice communications. In another embodiment, both users may use both text and voice communication. For example, a general conversation may occur via voice communication with private or sensitive information being communicated via a text chat feature. In a particular embodiment, the user may select a voice or text mode. Voice communications directed to a unit in text mode may be transcribed and presented in a text format and the unit may accept text messages that are converted to computer generated voice signals for play at a unit in voice mode. As network speeds increase, these methods may be adapted to streaming video and video conferencing methods.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A computer sever comprising:
a processor;
a communication module accessible to the processor and configured to communicate with a data network; and
computer readable memory accessible to the processor, the computer readable memory including:
computer implemented instructions operable by the processor to provide a medical data interface to a first remote device via the data network; and
computer implemented instructions operable by the processor to establish a packet-based voice communication link between the first remote device and a second remote device.

2. The computer server of claim 1, wherein the computer readable memory includes medical findings data.

3. The computer server of claim 2, wherein the medical findings data is selected from a group consisting of patient personal data, family medical and social histories, current medical findings, prescription data, medical orders, and test results.

4. The computer server of claim 2, wherein the computer implemented instructions operable by the processor to provide a medical data interface are configured to access the medical findings data.

5. The computer server of claim 1, wherein the computer readable memory includes computer implemented instructions operable by the processor to provide a selection interface configured for communication to the first remote device via the data network.

6. The computer server of claim 5, wherein the selection interface includes a list of available medical professionals.

7. (canceled)

8. The computer server of claim 1, wherein the packet-based voice communications link uses a voice-over-IP communications protocol.

9. The computer server of claim 1, wherein at least one of the first remote device and the second remote device is a wireless interface device.

10-16. (canceled)

17. The computer server of claim 1, wherein the computer readable memory also comprises computer implemented instructions operable by the processor to provide a second medical data interface to the second remote device.

18. The computer server of claim 17, wherein the second medical data interface includes discrete medical information entered on the first remote device associated with a currently selected patient of the medical data interface communicated to the first remote device.

19. (canceled)

20. A medical data communication device comprising:
a processor;
a communication module accessible to the processor and configured to communicate with a data network, the data network providing a data packet-based voice communication channel;
a user interface device accessible to the processor, and
memory accessible to the processor, the memory including:
computer implemented instructions operable by the processor to display a medical data interface using the user interface device; and
computer implemented instructions operable by the processor to communicate using the data packet-based voice communication channel.

21. The medical data communication device of claim 20, wherein the data network is a wireless data network.

22-26. (canceled)

27. The medical data communication device of claim 20, wherein the memory includes medical findings data and wherein the medical data interface is configured to access the medical findings data.

28. (canceled)

29. The medical data communication device of claim 20, wherein the memory further includes computer implemented instructions operable by the processor to implement a selection interface.

30. The medical data communication device of claim 29, wherein selection interface data associated with the selection interface is provided from a remote interface server via the data network.

31. The medical data communication device of claim 20, wherein updates to the medical findings data are transmitted to a remote machine.

32-45. (canceled)

46. A method of interacting with a medical professional, the method comprising:
providing medical data interface data to a remote interface device via a data network; and
establishing a packet-based voice communication link with the remote interface device via the data network.

47. The method of claim 46, further comprising providing selection interface data to the remote interface device via the data network.

48. (canceled)

49. The method of claim 47, further comprising displaying a medical data interface including a voice communications control element at the remote interface device wherein the medical data interface is configured to request a selection interface.

50. The method of claim 47, further comprising receiving a user selection from the remote interface device and establishing the packet-based voice communication link based on the user selection.

51-60. (canceled)
